(19) United States
(12) Patent Application Publication
(10) Pub. No.: US 2006/0233520 A1
(43) Pub. Date: Oct. 19, 2006

(54) METHOD FOR TRANSMITTING AND RECEIVING GRAPHIC DATA BETWEEN AN IMAGE DISPLAY APPARATUS AND AN EXTERNAL APPARATUS, AND INFORMATION FRAME STRUCTURE INCLUDING INFORMATION ON THE GRAPHIC DATA

(75) Inventor: Jaeyoon JUNG, Dongjak-Gu, Seoul (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/279,994

(22) Filed: Apr. 17, 2006

(30) Foreign Application Priority Data
Apr. 18, 2005 (KR) 10-2005-0032088

(51) Int. Cl. H04N 7/00

(52) U.S. Cl. 386/95

(57) ABSTRACT

Disclosed are a method for transmitting and receiving graphic data between an external apparatus and an image display apparatus and an information frame structure including information on the graphic data. The image display apparatus receives a predetermined graphic data such an OSD data, which is displayed by overlapping on a predetermined image, from the external apparatus via an IEEE 1394 interface and displays the graphic data. At this time, the image display apparatus receives in advance information on the graphic data from the external apparatus, thereby preventing same graphic data from being repetitively transmitted. This enables the external apparatus to be accomplished by assigning an identifier for each OSD data frame and transmitting information frame including the identifier information to the image display apparatus prior to transmission of the OSD data frame.

### CLAIM FOR PRIORITY

This application claims priority to Korean Patent Application No. 10-2005-0032088 filed on Apr. 18, 2005 in the Korean Intellectual Property Office (KIPO), the entire contents of which are hereby incorporated by reference.

### BACKGROUND

This description relates to a method for transmitting and receiving graphic data between an external apparatus and an image display apparatus and an information frame structure including information on the graphic data, by which same graphic data can be prevented from being repetitively transmitted by receiving in advance information on the graphic data from the external apparatus, when the image display apparatus receives a predetermined graphic data from the external apparatus and displays the predetermined graphic data which is displayed by overlapping on a predetermined image.

### DESCRIPTION OF THE RELATED ART

An Institute of Electrical and Electronics Engineers (IEEE) 1394 is a serial bus interface standard which was commonly announced by an Apple, INC. and a Texas Instruments in 1986. The IEEE 1394 was designed for exchange of large capacity of multimedia data between Audio/Video (A/V) products and was standardized by the IEEE in 1995.

The IEEE 1394 can transfer data at a high transfer speed of 100˜400 Mbps; currently, an IEEE 1394 with a data transfer speed of 800 Mbps or 1.6 Gbps is under development. The IEEE 1394 connects multimedia peripherals such as a scanner, a digital camera and a digital video camera directly to a personal computer (PC), and can transfer information such as digital audio or a moving picture in real time.

The IEEE 1394 supports two types of data transfer methods, that is, an asynchronous transfer and an isochronous transfer, and thus is suitable for a transmission of high-quality moving picture requiring a secure real-time transmission.

The IEEE 1394 has physical advantages in that the various types of peripherals can be simply connected by one common plug of a serial connector, and a thin serial cable is used rather than a thick parallel cable.

The IEEE 1394 supports Hot-plug and plug-and-play functions, all of which can be connected to the personal computer without disrupting the peripherals. The IEEE 1394 can also connect the peripherals using various methods without connection and complicate establishment of a terminal device.

Because of these advantages, currently, the number of IEEE 1394-adopted products has gradually increased. For example, the IEEE 1394 has been applied to a digital camcorder, a digital video editor, a digital VCR, a digital camera, a digital audio player, etc. Basic components related to the IEEE 1394, such as IEEE 1394 ICs, connectors, cables, test equipment, and software tool kits have been continuously announced. It is expected that this trend will continue in future.

Meanwhile, DTVLink, a Consumer Electronics Association (CEA) standard, is a method for transmitting a moving picture stream and On Screen Display (OSD data) between two devices which are connected via IEEE 1394 high-speed bus. The DTVLink is fundamentally based on an Electronic Industries Alliance (EIA)-775A standard.

The EIA-775A standard includes contents of an Asynchronous Serial Bus Connection (hereinafter referred to as “asynchronous connection”) standard and an EIA-799 standard for transmission of on screen display (OSD) data.

The asynchronous connection standard is used to transmit the OSD data from a producer to a consumer using an asynchronous method, and the EIA-799 standard defines a type of OSD data to be transmitted.

The DTVLink connection basically includes logical nodes of both the producer for sending the moving picture stream and the OSD data and the consumer for receiving the moving picture stream and OSD data and displaying on a screen.

The OSD data transmitted from the producer usually includes a user interface (UI) with current state information and control information for the producer.

The consumer displays the OSD on its own display apparatus to enable a user to control the producer through the consumer.

The consumer takes a passive stand of only displaying on its own screen the OSD transmitted from the producer without specific processing. In other words, the producer changes the OSD data in response to an input of the user and transmits a new OSD data, and the consumer only receives the transmitted OSD data and displays it on a screen.

However, since the consumer performs only operations of displaying the OSD data as it is, there is not a conventional method that can divide the transmitted OSD data into a frame unit. Accordingly, when a previously displayed specific OSD data frame needs to be redisplayed on the screen, the producer should resend same OSD data to the consumer. This causes the transmission efficiency of the OSD data to be deteriorated. Specially, when the transmission of a large amount of OSD data is required, redundant data is continuously transmitted, thereby causing a band width to be unnecessarily used.

### SUMMARY

An object of the present invention is to provide a method for transmitting and receiving graphic data between an external apparatus and an image display apparatus and an information frame structure including information on the graphic data, by which same graphic data can be prevented from being repetitively transmitted by receiving in advance information on the graphic data from the external apparatus, when the image display apparatus receives from the external apparatus a predetermined graphic data which is displayed by overlapping on a predetermined image and displays the graphic data on a screen.

According to a first aspect of the present invention, there is provided a method for transmitting and receiving graphic data in an image display apparatus, comprising: requesting at least one graphic data transmission for a graphic image, which is displayed by overlapping on a predetermined image, to an external apparatus while the predetermined image is displayed on a screen of the image display apparatus; receiving information data including information on the at least one graphic data which is transmitted from the external apparatus in response to the request; and requesting the transmission of the at least one graphic data after receiving the information data, and requesting a subsequent graphic data of the at least one graphic data if the at least one graphic data to be transmitted have already been received and stored when judging on the basis of the information data.

The method may further comprise receiving information data on the subsequent graphic data which is transmitted from the external apparatus in response to the request for the subsequent graphic data transmission from the image display apparatus.

The step of requesting the subsequent graphic data transmission may further comprise, displaying a corresponding graphic image based on the already stored graphic data if the graphic data to be transmitted have already been received and stored.

The respective steps may be performed via an IEEE 1394 interface in conformity with a CEA-775B standard. The graphic data may be an OSD data and the at least one graphic data may be a snapshot data that is a group of a plurality of OSD data.

If the graphic data is the OSD data, the information data may include a “TypeCode” field indicating an OSD information data, a “datalength” field including information on the length of the information data, and a “Frame ID” field in which an identifier (e.g., frame ID) of one OSD data to be transmitted after transmitting the information data is written.

If the at least one graphic data is the snapshot data, the information data may include a “TypeCode” field indicating a snapshot information data, a “datalength” field including information on a length of the information data, and a “Frame ID” field in which identifiers (e.g., frame IDs) of the plurality of the OSD data included in the snapshot data to be transmitted after transmitting the information data are written.

Moreover, the respective steps may be followed by an asynchronous serial bus connection of the IEEE 1394. In this case, the transmission request of the subsequent graphic data is performed by a process that writes a predetermined value corresponding to the transmission request of the subsequent graphic data to an output asynchronous port register (oAPR) of the external apparatus.

According to a second aspect of the present invention, there is provided information data including information on at least one graphic data, which is transmitted to an image display apparatus, prior to transmitting the at least one graphic data from an external apparatus, wherein the external apparatus transmits a predetermined image data and the at least one graphic data for a graphic image to be displayed by overlapping on an image corresponding to the image data.

A structure of the information data may include a “TypeCode” field indicating an information data, a “datalength” field including information on a length of the information data, and a “Frame ID” field in which identifiers (e.g., frame IDs) of the at least one graphic data to be transmitted after transmitting the information data is written.

The graphic data is one ODS data, and the information data may include an identifier of one OSD data to be transmitted.

The graphic data also is a snapshot data including a plurality of OSD data, and the information data may include identifiers of the plurality of OSD data to be transmitted.

According to a third aspect of the present invention, there is provided a method for transmitting and receiving graphic data in an external apparatus connected to an image display apparatus, comprising: receiving from the image display apparatus a transmission request for at least one graphic data of an graphic image to be displayed by overlapping on the predetermined image while a predetermined image is displayed on the image display apparatus; outputting information data including information on the at least one graphic data to the image display apparatus, in response to the request; outputting the at least one graphic data to the image display apparatus, when the transmission request for the at least one graphic data is received again from the image display apparatus after outputting the information data; and outputting information data including information on the subsequent graphic data to the image display apparatus when a transmission request for a subsequent graphic data following the at least one graphic data after outputting the information data is received from the image display apparatus.

### BRIEF DESCRIPTION OF THE DRAWINGS

FIG. 1 is a schematic diagram illustrating a connection between an image display apparatus and an external apparatus according to one exemplary embodiment of the present invention.

FIG. 2 is a diagram illustrating an example of an image according to an OSD data.

FIG. 3 is a diagram illustrating an example of an image according to a snapshot data frame.

FIG. 4 is a diagram illustrating a useful situation of the snapshot data frame.

FIG. 5 is a diagram illustrating structures of an OSD information frame and a snapshot information frame according to another exemplary embodiment of the present invention.

FIG. 6 is a diagram illustrating “oAPR” mode according to the embodiment of the present invention.

FIGS. 7 to 9 are flowcharts explaining an OSD data transmission method according to still another exemplary embodiment of the present invention.

FIG. 10 is a conceptual diagram of an OSD data frame cache which a consumer manages.

### DETAILED DESCRIPTION

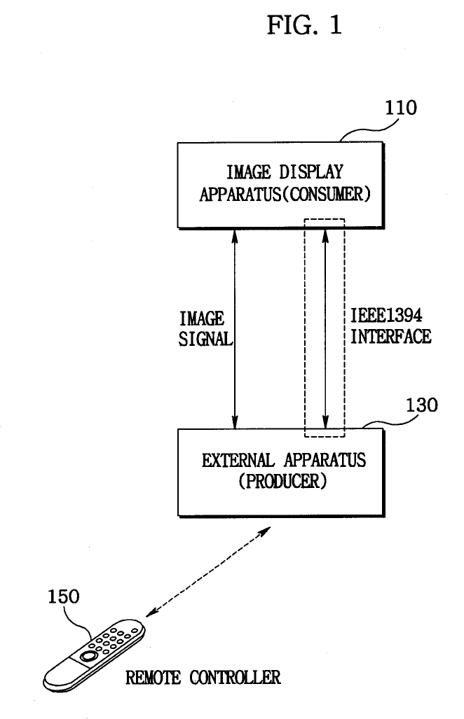

Referring to FIG. 1, an image display apparatus 110 is connected to an external apparatus 130.

The external apparatus 130 transmits a predetermined digital image signal to the image display apparatus 110, and is connected to the image display apparatus 110 via an IEEE 1394 interface. The external apparatus 130 also includes a set top box (STB) which can output a digital image signal.

The external apparatus 130 transmits a predetermined graphic data to the image display apparatus 110 via the IEEE 1394 interface. The external apparatus 130 generates the graphic data corresponding to a control command of a user, which is inputted through a remote controller 150, and others, and transmits the generated graphic data to the image display apparatus 110 to enable a predetermined user interface for the control command of the user to be displayed. A graphic image consisting of the graphic data is displayed by overlapping on an image on which the image display apparatus 110 displays. The graphic data includes an on screen display (OSD) data, and others.

The image display apparatus 110 can receive a digital image signal which is transmitted from the external apparatus 130 and display it on a screen, and also can receive the graphic data which is transmitted from the external apparatus 130 via the IEEE 1394 interface. The image display apparatus 110 converts the received graphic data into an image data using a predetermined method, and can display the converted image data by overlapping on an already displayed image.

If the image display apparatus 110 is a digital television (hereinafter referred to as “DTV”), preferably a CEA standard, for example, CEA-775B or EIA-775B, which is related to DTV-IEEE 1394 interface, is supported.

Hereinafter, the image display apparatus 110 is referred to as a “consumer” and the external apparatus 130 is referred to as a “producer”. The consumer 110 and producer 130 establish a predetermined “DTVLink” therebetween. For convenient explanation, the OSD data and the snapshot data, among the graphic data, will be explained below. The “snapshot data” means a group of two or more OSD data frames, which will be explained in further detail below.

The producer 130 transmits the OSD data and the snapshot data to the consumer 110. At this time, the producer 130 transmits in advance information on the OSD data and the snapshot data, to be transmitted, prior to transmission of the OSD data and snapshot data.

Accordingly, the producer 130 assigns an unique OSD identifier “frame ID” to each frame of the OSD data to be transmitted to the consumer 110, and sends an OSD information frame including the OSD identifier to the consumer 110 prior to transmitting the OSD data frame. It is judged whether the consumer 110 needs re-transmission of the OSD data frame based on the OSD identifier “frame ID”.

Furthermore, the producer 130 defines a snapshot including OSD data frames and sends the snapshot information frame to the consumer 110.

The consumer 110 discriminates whether the OSD data and snapshot data, to be transmitted, have been already received, on the basis of the OSD information frame and snapshot information frame which are transmitted from the producer 130. As a result of the discrimination, if the OSD data and snapshot data have been already stored, the consumer 110 enables the producer 130 not to send the OSD data and snapshot data. Accordingly, the traffic of the data, which is transmitted from the producer 130 to the consumer 110, decreases, and the consumer 110 may also decrease troublesomeness of receiving and processing the OSD data every time.

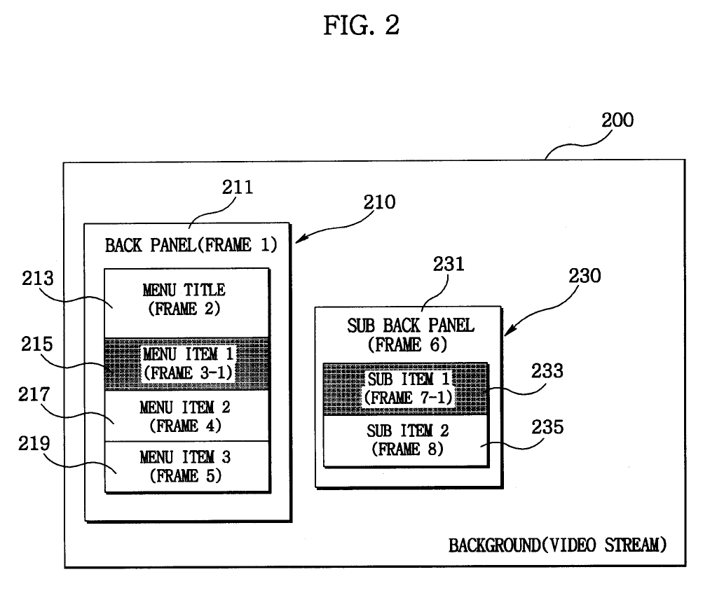

A graphic data being transmitted from the producer 130 to the consumer 110 will be explained with reference to FIGS. 2 to 4.

In FIG. 2, it is assumed that the consumer 110 would receive the graphic data together with a predetermined image from the producer 130. For convenient explanation, it is assumed that the graphic data is an OSD data. It is also assumed that the OSD data corresponds to a control command inputted by the user in order to control the producer 130 or the consumer 110 and consists of a menu screen.

Referring again to FIG. 2, a display unit (not shown) of the consumer 110 displays a predetermined image. This image may be generated by a digital image signal or a usual analog image signal included on Transport Stream (TS).

The consumer 110 displays first and second menu screens 210 and 230, which are produced by the OSD data transmitted via the IEEE 1394 interface, by overlapping on an already-displayed image.

The first menu screen 210 includes a back panel 211, a menu title 213, and unit menu items 215, 217 and 219. The second menu screen 230 includes a back panel 231 and unit menu items 233 and 235. The back panels 211 and 231, the menu title 213 and unit menu screens 215, 217, 219, 233 and 235 are corresponded to each unit OSD data frame.

The respective unit OSD data frames are provided with a unique OSD identifier “frame ID”. Accordingly, the OSD data having same OSD identifier “frameID” corresponds to the same OSD data frame supported by CEA-775B standard.

For example, if the OSD identifier is a frame 2, it corresponds to CEA-775B OSD data frame corresponding to the menu title 213 of FIG. 2, and the OSD identifiers, i.e., frame 3 and frame 3-1 respectively correspond to a menu item 1 (not shown) and a highlighted menu item 1 215. In other words, the highlighted menu item 1 215 is displayed by overlapping on the menu item 1 (not shown) that have been already displayed by the user's operation.

The producer 130 assigns the OSD identifier “frame ID” to all the OSD data frames, which are transmitted to the consumer 110.

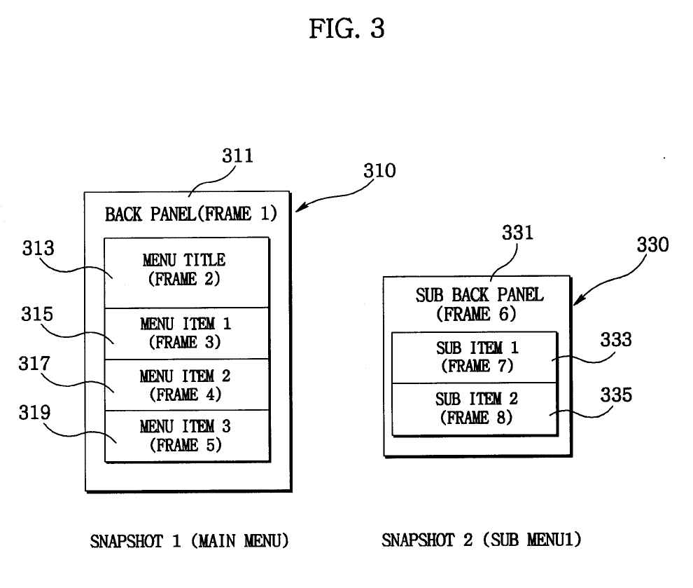

Additionally, when providing a first menu screen 210 and a second menu screen 230, as shown in FIG. 2, the producer 130 can be defined by snapshots 310 and 330 as a group of the plurality of unit OSD data, as shown in FIG. 3.

Meanwhile, there is an order among the OSD data frames comprising the snapshots. For example, in FIG. 3, the OSD data frames comprising the snapshot 310 become arranged in following order: a frame 1 311, a frame 2 313, a frame 3 315, a frame 4 317, and a frame 5 319. This order can actually correspond to an order of displaying on a screen of the consumer 110.

Accordingly, the snapshots may be used to manage the OSD data frames as one group.

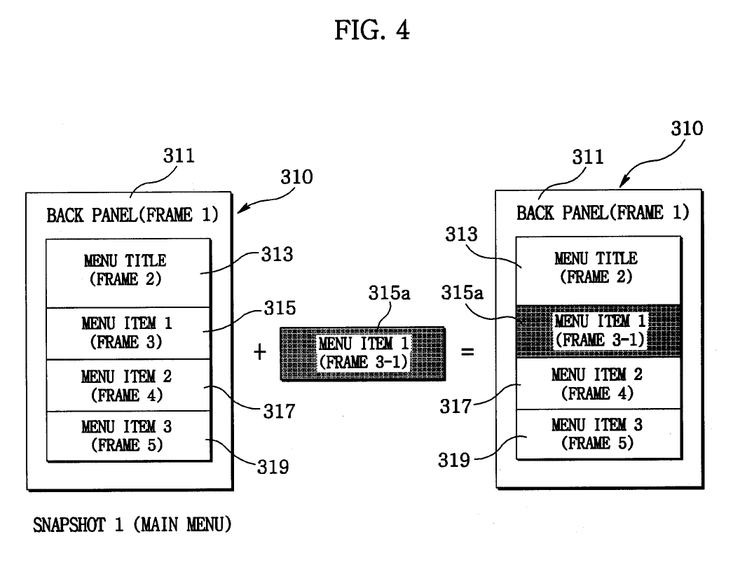

For example, the producer 130 defines frames necessary for displaying a basic menu screen for a user interface on the screen of the consumer 110 as the snapshot 310 of FIG. 3. Additionally, if the producer 130 sends a highlighted menu item 1 (i.e., frame 3-1) 315a (shown in FIG. 4) to the consumer 110, the consumer 110 can display an OSD of the highlighted menu item 1 on the menu screen 310.

As described above, the producer 130 sends information on data, to be transmitted, to the consumer 110 beforehand prior to transmission of the OSD data or the snapshot data, as explained in FIGS. 2 to 4. If the OSD data, the snapshot data or their information which is received from the producer 130 is not an already-received stored data or information, the consumer 110 stores these data or information in order to display a predetermined image.

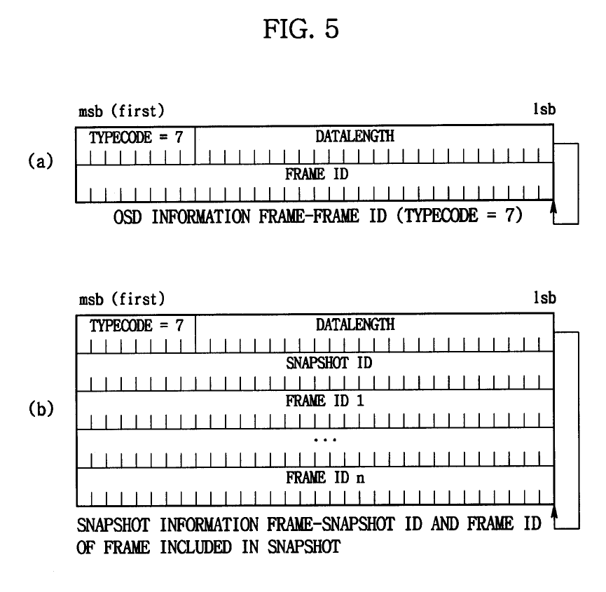

Hereinafter, a method for transmitting an OSD data, a snapshot data and their information from the producer 130 will be explained with reference to FIGS. 5 to 9.

The OSD information frame and snapshot information frame are basically explained in the same way as in a data frame which is defined by CEA-775B-adopted EIA-799 standard except for some matters. The OSD information frame and snapshot information frame are also sent from the producer 130 to the consumer 110 via the CEA-775B-adopted asynchronous serial bus connection.

The OSD information frame (a) is constituted by total 8 bytes. A first 1-byte is a “TypeCode” field. The “TypeCode” field indicates that the frame is predetermined OSD information. A value of the “TypeCode” field may be variously defined, but it is preferable that the value be a reserved assigned “7” in the EIA-799 or CEA-775B.

Following the “TypeCode” field, a 3-byte field is a “datalength” field and includes information on the length of the transmitting OSD information frame.

The last 4-byte is “Frame ID” field and writes an identifier “frame ID” of the OSD data frame to be transmitted after the OSD information frame.

The number of OSD data frames included in one snapshot is not identical because the snapshot is a group of two or more OSD data frames. Accordingly, a length of a snapshot information frame (b) changes depending on the number of OSD data frames which the snapshot includes.

A first 1-byte of the snapshot information frame (b) is a “TypeCode” field. The “TypeCode” field indicates that the frame is a predetermined snapshot information frame. A value of the “TypeCode” field may be variously defined, but it is preferable that the value be a reserved assigned “8” in the EIA-799 or CEA-775B.

Following the “TypeCode” field, a 3-byte field is a “datalength” field and includes information on the length of the transmitted snapshot information frame.

The remainder of the snapshot information frame is a “Frame ID” field of the OSD data frame included in the snapshot and writes an identifier “frame ID” of the OSD frame data included in the snapshot to be transmitted following the snapshot information frame.

On the basis of the OSD information frame and snapshot information frame, the consumer 110 compares the OSD data and snapshot data, to be transmitted, with already-stored OSD data and snapshot data. If the OSD data and snapshot data to be transmitted are identical to the already-stored OSD data and snapshot data, the consumer 110 enables the producer 130 not to send the OSD data and snapshot data to be transmitted. Accordingly, the present invention provides a new protocol for such an operation of the consumer 110.

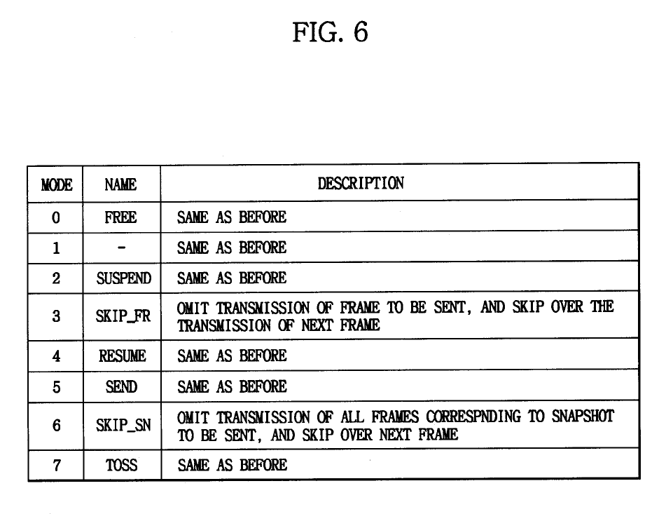

FIG. 6 is a diagram illustrating “oAPR” mode according to an embodiment of the present invention.

The present invention uses an output asynchronous port resister (oAPR) mode as well as an input APR (iAPR) mode. These modes are defined for a data communication between the producer 130 and the consumer 110 in conformity with CEA-775B adopted IEEE 1394 asynchronous serial bus connection standard (issued by IEEE 1394 Trade Association).

In conformity with the asynchronous serial bus connection standard, communication between the producer 130 and the consumer 110 via the IEEE 1394 interface is performed by transmission of a predetermined logical port register value.

The oAPR mode is a control command which is sent from the consumer 110 to the producer 130 via the IEEE 1394 interface. The consumer 110 transfers the control command using a process of writing a desired value in an output register of the producer 130.

Meanwhile, the iAPR mode is a control command which is sent from the producer 130 to the consumer 110 via the IEEE 1394 interface. The producer 130 transfers a desired control command using a process of writing an input register value of the consumer 110.

The present invention defines new oAPR modes, a “SKIP_FR” and a “SKIP_SN”, and make use of a reserved defined value in conformity with an existing standard.

If the consumer 110 sets a value of the oAPR mode of the producer 130 at the “SKIP_FR”, it means that the producer 130 omits the transmission of the OSD data frame to be sent following the already transmitted ODS information frame and requests the transmission of the next frame.

If the producer 130 receives the “SKIP_FR” from the consumer 110, the producer 130 should not transmit the OSD data frame on the basis of the OSD information frame, and transmits the next OSD data frame to the consumer 110.

If the consumer 110 sets the value of the oAPR mode of the producer 130 at the “SKIP_SN”, it is a request from the consumer 110 that the producer 130 omits the transmission of the OSD data frame of the snapshot to be transmitted and OSD data frames included in the next snapshot.

If the producer 130 receives the “SKIP_SN” from the consumer 110, two or more OSD data frames corresponding to the transmitted snapshot information frames are not transmitted, and the next OSD data frame or snapshot frame is transmitted to the consumer 110.

The “SKIP_FR” and “SKIP_SN” are basically processed in the same fashion as that of an existing “SEND” command in an asynchronous connection processing routine, except that the OSD data frame to be transmitted is changed.

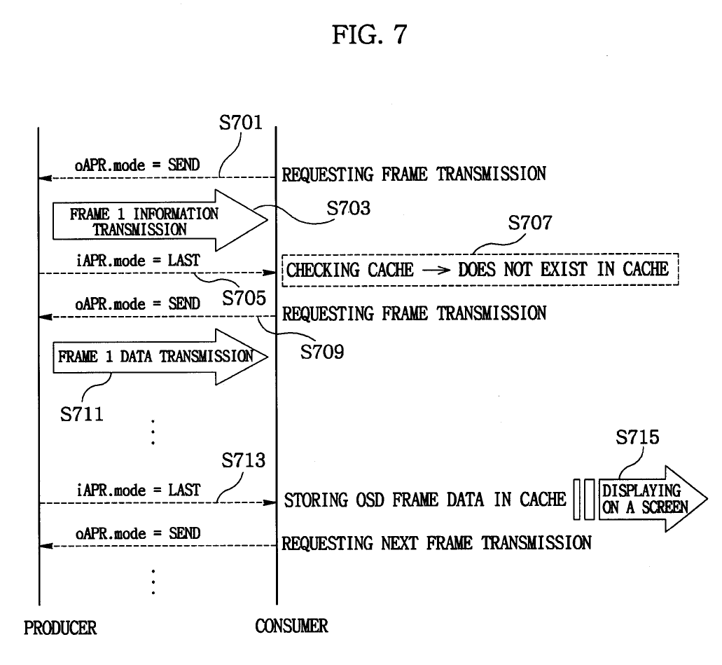

FIGS. 7 to 9 are flowcharts explaining an OSD data transmission method according to another embodiment of the present invention.

The CEA-775B (or EIA-775A) adopted IEEE 1394 asynchronous serial bus connection standard is basically applied to the explanation of a method for transmitting and receiving data between the producer 130 and the consumer 110, as shown in FIGS. 7 to 9.

Referring to FIG. 7, the consumer 110 sends a “SEND” command to the producer 130 and requests the transmission of the OSD data frame. In FIG. 7, “oARP.mode=SEND” indicates that a control command “SEND” is written in an output register of the producer 130.

The producer 130 sends the OSD information frame after receiving “SEND” command S703, and “LAST” is written as a value of the iAPR mode S705.

The consumer 110 discriminates whether an identifier “frameID” written in “Frame ID” field is the same as an already-stored identifier, in which the “Frame ID” field is included in the OSD information frame received from the producer 130 S707.

If the OSD identifier “frameID” included in the OSD information frame is not the already-stored identifier, the consumer 110 sets the oARP mode at “SEND” to request the OSD data frame of the producer 130 S709.

The producer 130, which has received the “SEND” command from the consumer 110, transmits the OSD data frame S711.

If “LAST” is received from the producer 130 as a value of the APR mode, the consumer 110 stores the received OSD data and displays an image corresponding to the OSD data S715.

Meanwhile, if an identifier included in the received OSD information frame from the producer 130 is an already-stored identifier, the consumer 110 need not receive back the OSD data frame from the producer 130.

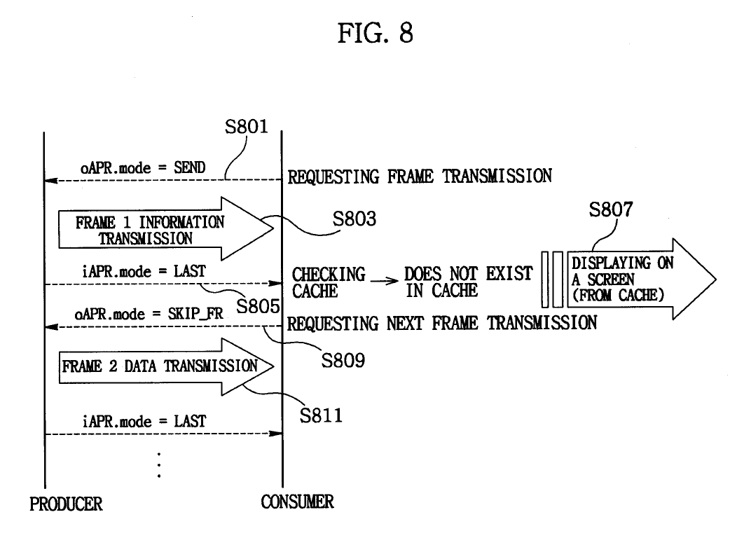

Referring to FIG. 8, if the consumer 110 transmits “SEND” command to the producer 130 and requests the transmission of the OSD data frame S801, the producer 130 sends the OSD information frame S803 and transmits “LAST” as the value of the APR mode S805.

As a result of the discrimination based on the OSD information frame received from the producer 130, if the OSD data frame 1 has been already stored, the consumer 110 displays an image corresponding to the already-stored OSD data frame 1 on a screen. As a result thereof, the consumer 110 displays an image which the producer 130 tries to display, without re-transmission of the producer 130 S807. The consumer 110 sets the APR mode at “SKIP_FR” so as to be transferred to the producer 130 S809.

The producer 130, which has received the “SKIP_FR”, does not transmit the OSD data frame but the next OSD information frame. Since the value “SKIP_FR” of the APR mode includes its own “SEND” function, the consumer 110 need not transmit separately “SEND” and the transmission of the next information frame is required by the “SKIP_FR” S811.

The consumer 110 repeats processes as described in FIG. 7 or 8 on the basis of an OSD information frame which is newly transmitted by the producer 130 received “SKIP_FR”.

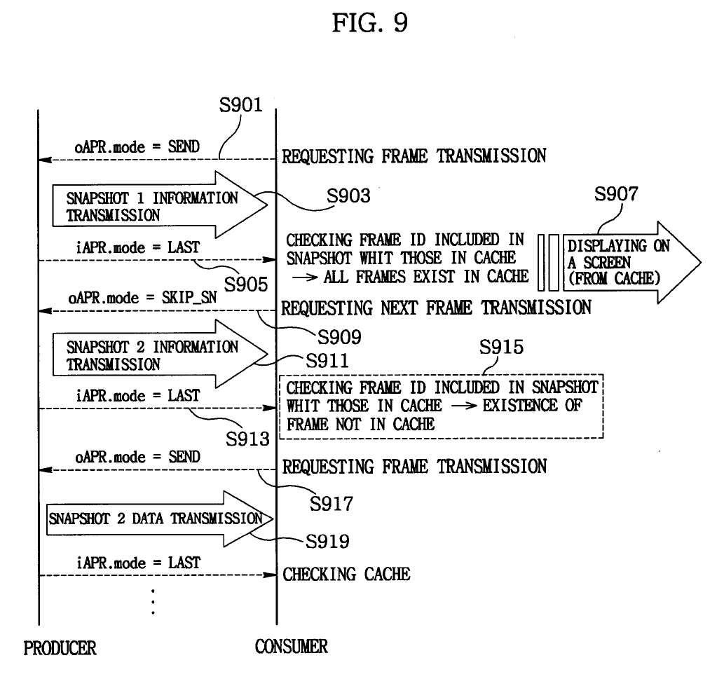

Referring to FIG. 9, if the consumer 110 transmits “SEND” command to the producer 130 and requests the transmission of the OSD data frame S901, the producer 130 sends the snapshot information frame S903 and transmits “LAST” as the value of the APR mode after completion of the transmission of the snapshot information frame S905.

As a result of discrimination based on the snapshot information frame received from the producer 130, if all OSD data frame identifiers “frame IDs” written in a “Frame ID” field, that is included in the snapshot information frame, has been already stored, the consumer 110 displays an image corresponding to the at least one OSD data frame included in the snapshot data on a screen S907. The consumer 110 sets the APR mode at “SKIP_SN” so as to be transferred to the producer 130 S909.

The producer 130, which has received the “SKIP_FR”, does not transmit the corresponding snapshot data frame but the next OSD information frame or snapshot information frame S911. The producer 130 transmits “LAST” as the value of the APR mode after completion of the transmission of the next snapshot information frame S913.

As a result of discrimination based on the snapshot information frame received from the producer 130 S915, if any one of OSD data frame identifiers “frame ID” written in a “Frame ID” field, that is included in the next snapshot information frame, has not been already stored, the consumer 110 transmits the “SEND” command to request the transmission of the corresponding snapshot data S917.

If the “SEND” command is received by the producer 130, the producer 130 transmits a corresponding snapshot data frame to the consumer 110 S919.

The consumer 110 receives the OSD data or snapshot data from the producer 130 to display an image corresponding to the OSD data or snapshot data, using methods described in FIGS. 7 to 9.

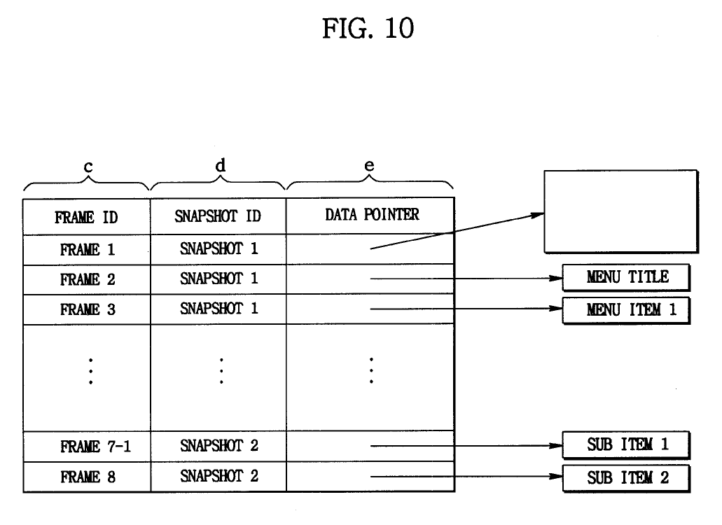

Now, referring to FIG. 10, the consumer 110 may store the OSD data or snapshot data which is received form the producer 130 a memory or the other recording medium and store the information of the OSD data or snapshot data in a cache memory. If the OSD information frame or snapshot information frame is received from the producer 130, the consumer 110 can discriminate whether the corresponding OSD data is an already-received stored data, by comparing with information stored in the cache.

Each entry of the cache includes (c) an identifier area of the OSD data frame, (d) an identifier “snapshotID” area of a snapshot, when a corresponding frame is included in the snapshot, and (e) a pointer area for the memory in which an actual OSD data is stored.

When the producer 130 has sent the OSD information frame prior to sending the data frame, the consumer 110 searches for an entry corresponding to the identifier “frameID” in the identifier area (c) of the OSD data frame of the cache.

If the search entry has been already written in the cache, it indicates that the corresponding data frame has been transmitted from the producer 130 beforehand and stored in the consumer 110. The consumer 110 extracts the corresponding OSD data using the value of the pointer area (e) to display an image.

Meanwhile, if the producer 130 sends the snapshot information frame, the consumer 110 searches for an entry corresponding to the identifiers “frame IDs” of all OSD data frames, in which the corresponding snapshot is included, from the identifier area (c) of the OSD data frame of the cache.

As described above, there are advantages in the present invention in that the image display apparatus (or consumer) stores the OSD data frame received from the external apparatus (or producer) in its own memory, and the external apparatus assigns the unique ID for each OSD data frame so that the image display apparatus can receive only the OSD data which is not stored in its own memory of the image display apparatus, thereby minimizing the unnecessary re-transmission of ODS data as well as improving transmission speed of the OSD.

Further, there are other advantages in that the invention defines the snapshot concept which manages two or more OSD data frames as one group so that re-transmission of the OSD data may be reduced in a snapshot unit, thereby allowing a total transmission data amount to be reduced when the producer transmits a specific OSD screen many times.

The present invention may be implemented by a method, a device and a system.

When the invention is implemented by computer software for simulation, and the like, elements of the invention may be replaced with a code segment required for performing necessary operations. Programs or code segments may be stored in the media that can be processed by a microprocessor, and be transmitted via transmitting media or telecommunication networks as computer data combined with carrier waves.

The media that can be processed by the microprocessor includes electronic circuits, semiconductor memory devices, ROMs (Read-Only Memories), a flash memory, EEPROM (Electrically Erasable and Programmable ROMs), a floppy disk, optical disk, a hard disk, optical fiber, a wireless network, etc., all of which can transfer and store information. Additionally, computer data includes data that can be transferred through an electrical network channel, optical fiber, an electromagnetic field, and a wireless network

It should be understood by those of ordinary skill in the art that various replacement, modifications and changes in the form and details may be made therein without departing from the sprit and scope of the present invention as defined by the following claims. Therefore, it is to be appreciated that the above described embodiments are for purpose of illustration only and are not to be construed as limitations of the invention.

What is claimed is:

1. A method for transmitting and receiving a graphic data in an image display apparatus, comprising:
requesting at least one graphic data transmission for a graphic image, which is displayed by overlapping on a predetermined image, to an external apparatus while the predetermined image is displayed on a screen thereof;
receiving an information data including information on the at least one graphic data which is transmitted from the external apparatus in response to the request;
judging whether the at least one graphic data to be transmitted has been already received and stored, on the basis of the information data;
requesting the at least one graphic data transmission if the at least one graphic data to be transmitted has not already received and stored; and
requesting the transmission of a subsequent graphic data of the at least one graphic data, if the at least one graphic data to be transmitted has been already received and stored.

2. The method of claim 1, further comprising: receiving information data of the subsequent graphic data, which is transmitted from the external apparatus, in response to the transmission request for the subsequent graphic data.

3. The method of claim 1, wherein the step of requesting the transmission of the subsequent graphic data further comprise displaying a corresponding graphic image based on the already-stored graphic data.

4. The method of claim 1, wherein the respective steps are performed via an IEEE 1394 interface in conformity with a CEA-775B standard.

5. The method of claim 4, wherein if the graphic data is an OSD data, the information data include a “TypeCode” field indicating an OSD information data, a “datalength” field including information on a length of the information data, and a “Frame ID” field in which an identifier (frame ID) of one OSD data to be transmitted following transmission of the information data is written.

6. The method of claim 4, wherein if the at least one graphic data is a snapshot data which is grouped by a plurality of the OSD data, the information data include a “TypeCode” field indicating a snapshot information data, a “datalength” field including information on a length of the information data, and a “Frame ID” field in which identifiers (e.g., frame IDs) of the plurality of the OSD data included in the snapshot data to be transmitted following transmission of the information data are written.

7. The method of claim 4, wherein the respective steps are followed by an asynchronous serial bus connection of the IEEE 1394, and the transmission request of the subsequent graphic data is performed by a process of writing a predetermined value corresponding to the transmission request of the subsequent graphic data to an output asynchronous port register (oAPR) of the external apparatus.

8. An information frame structure including information on at least one graphic data which is transmitted to an image display apparatus beforehand prior to transmission of the at least one graphic data from an external apparatus, in which the external apparatus transmits an image data and the at least one graphic data for a graphic image to be displayed by overlapping on an image corresponding to the image data, comprising:
a “TypeCode” field indicating an information data;
a “datalength” field including information on a length of the information data; and
a “Frame ID” field in which identifiers (e.g., frame IDs) of the at least one graphic data to be transmitted following transmission of the information data are written.

9. The information frame structure of claim 8, wherein the graphic data is one OSD data, and the information data includes an identifier of the OSD data to be transmitted.

10. The information frame structure of claim 8, wherein the graphic data is a snapshot data including a plurality of OSD data, and the information data includes identifiers of the plurality of OSD data to be transmitted.

11. A method for transmitting and receiving graphic data in an external apparatus, comprising:
receiving a transmission request for at least one graphic data of an graphic image to be displayed by overlapping on a predetermined image from an image display apparatus on which the predetermined image is being displayed;
outputting, in response to the request, an information data including information on the at least one graphic data to the image display apparatus;
outputting the at least one graphic data to the image display apparatus, when a transmission request for the at least one graphic data is again received from the image display apparatus following output of the information data; and
outputting information data including information on the subsequent graphic data to the image display apparatus when a transmission request for a subsequent graphic data of the at least one graphic data following output of the information data is received from the image display apparatus.

12. The method of claim 11, wherein the respective steps are performed via an IEEE 1394 interface in conformity with a CEA-775B standard.

13. The method of claim 12, wherein if the graphic data is an OSD data, the information data include a “TypeCode” field indicating an OSD information data, a “datalength” field including information on a length of the information data, and a “Frame ID” field in which an identifier (frame ID) of one OSD data to be transmitted after transmitting the information data is written.

14. The method of claim 12, wherein if the at least one graphic data is a snapshot data which is grouped by a plurality of the OSD data, the information data include a “TypeCode” field indicating a snapshot information data, a “datalength” field including information on the length of the information data, and a “Frame ID” field in which identifiers (e.g., frame IDs) of the plurality of the OSD data included in the snapshot data to be transmitted following transmission of the information data are written.
